(19) United States
(12) Patent Application Publication
(10) Pub. No.: US 2021/0165802 A1
(43) Pub. Date: Jun. 3, 2021

(54) CONTEXT MAP BOARDS

(71) Applicant: BrainSquall, Inc., Bainbridge Island, WA (US)

(72) Inventor: Mark D. Bullard, Bainbridge Island, WA (US)

(21) Appl. No.: 17/109,401

(22) Filed: Dec. 2, 2020

Related U.S. Application Data
(60) Provisional application No. 62/943,231, filed on Dec. 3, 2019.

(51) Int. Cl. G06F 16/25; G06F 16/26; G06F 16/215; G06F 40/18; G06F 40/137

(52) U.S. Cl. CPC G06F 16/252; G06F 16/26; G06F 40/137; G06F 40/18; G06F 16/215

(57) ABSTRACT

A context map board system generates a multi-window context map board having multiple coupled interfaces that allow users to simultaneously interact with and visualize data in multiple views. The context map board system may store data in a database as elements with multiple mappings, each mapping associated with an interface. The mappings couple one or more elements to multiple interfaces such that modifications made to one element are propagated to each interface including that element. In one example, the views of the data include a canvas interface, an outline interface, and a table interface.

### CROSS-REFERENCE TO RELATED APPLICATIONS

This application claims the benefit of U.S. Provisional Patent Application Ser. No. 62/943,231, filed Dec. 3, 2019, which is incorporated by reference.

### TECHNICAL FIELD

The disclosure generally relates to data visualization, and in particular to the generation of multi-interface context map boards.

### BACKGROUND

Current data visualization solutions can often generate different views of data in different interfaces. However, these solutions do not correlate changes made in one view to other views. This requires users to manually propagate changes to each view individually, which can be costly and cause data entry errors. Additionally, some types of data points or insights may enrich the information presented, but may be difficult to convey in certain types of interfaces. For example, a user may wish to include comments in a spreadsheet to provide important context for values presented in the sheet, but these comments may not show up when the user prints the sheet or may be relegated to footnotes and presented out of context. While the user can create a separate document or interface more conducive to the data type, manual linking of different interfaces can be labor-intensive and error-prone.

### SUMMARY

A context map board system generates and stores multiple coupled interfaces that allow users to simultaneously interact with and visualize data in multiple views in a single user interface. In one embodiment, the coupled interfaces include a canvas interface, an outline interface, and a table interface. Data displayed in the interfaces is stored (e.g., in a database) as elements with multiple mappings, each mapping corresponding to an interface. The mappings couple the elements to the interfaces such that modifications made to an element in a first interface are automatically propagated to each interface including that element. For example, an element may be added, moved, edited, or removed from a first interface, and engines associated with the second and third interfaces automatically update those interfaces in accordance with the changes to the first interface. In this way, the user can view the same elements in multiple formats and interact with data in multiple ways. The different interfaces may also allow the users to easily compare and analyze data across different entities, such as departments or companies, by generating layers of the context map board to capture the same types of information for multiple entities.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 illustrates a system environment suitable for providing context maps, in accordance with an embodiment.

FIG. 2 is a block diagram of an architecture of the context map board system of FIG. 1, in accordance with an embodiment.

FIG. 3 is an example user interface for a context map board, in accordance with an embodiment.

FIG. 4 is an additional example user interface associated with a use case for a context map board, in accordance with an embodiment.

FIG. 5 is a flowchart of a method for automatically updating coupled interfaces of a context map board based on user input, in accordance with an embodiment.

FIG. 6 is a block diagram illustrating a computing device suitable for use as a context map board system, in accordance with an embodiment.

### DETAILED DESCRIPTION

The Figures and the following description relate to preferred embodiments by way of illustration only. It is noted that wherever practicable similar or like reference numbers may be used in the figures and may indicate similar or like functionality. One skilled in the art will readily recognize from the following description that alternative embodiments of the structures and methods illustrated herein may be employed without departing from the principles described herein.

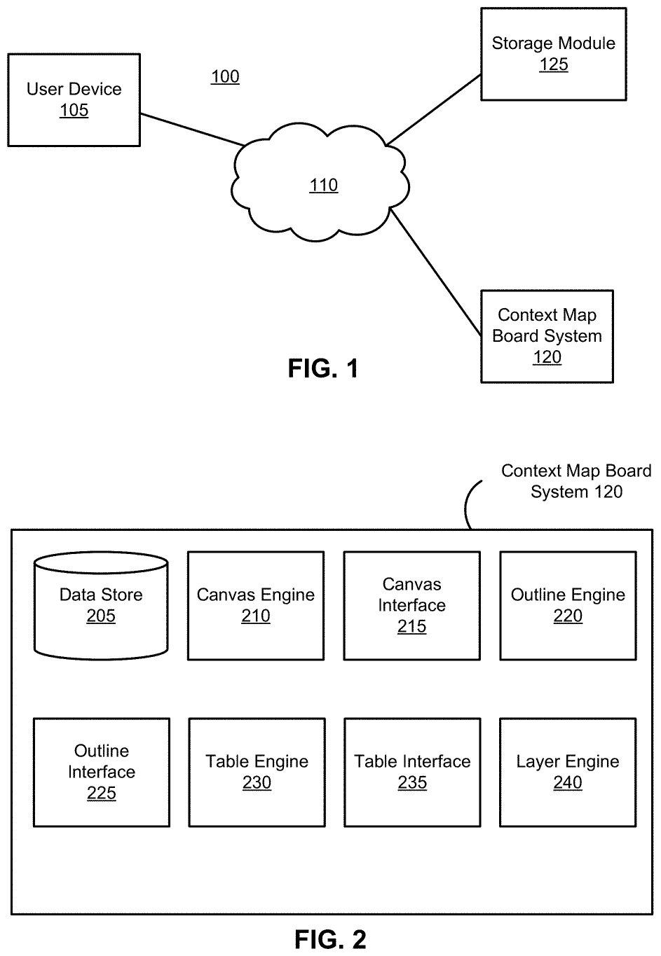

FIG. 1 illustrates one embodiment of a system environment 100 of a context map board system 120. In the embodiment shown, the environment 100 includes a user device 105, a network 110, a storage module 125, and the context map board system 120. In other embodiments, the system environment 100 includes different and/or additional elements. In addition, the functions may be distributed among the elements in a different manner than described.

The user device 105 is one or more computing devices capable of receiving user input as well as transmitting and/or receiving data via a network 110. In one embodiment, a user device 105 is a computer system, such as a desktop or a laptop computer. Alternatively, a user device 105 may be a device having computer functionality, such as a personal digital assistant (PDA), a mobile telephone, a smartphone, or another suitable device. A user device 105 is configured to communicate via the network 110. The user device 105 may execute an application allowing a user of the user device 105 to interact with the context map board system 120 via a user interface. For example, a web browser application may enable interaction between the user device 105 and the context map board system 120 via the network 110 or a graphical user interface may be provided as part of a software application published by the context map board system 120 and installed on the user device 105. Alternatively, a user device 105 interacts with the context map board system 120 through an application programming interface (API) running on a native operating system of the user device 105, such as IOS® or ANDROID™.

The context map board system 120 includes one or more computing devices (e.g., a server). The context map board system generates and stores multiple interfaces that allow users to simultaneously interact with and visualize a data set in multiple views. In one embodiment, the context map board system 120 does this by storing data in a database (e.g., in the storage module 125) as elements with multiple mappings, each mapping associated with an interface. The mappings couple one or more elements to multiple interfaces such that modifications made to one element are propagated to each interface including that element. In some embodiments, users may view data within user interfaces, each corresponding to a canvas interface, an outline interface, and a table interface, discussed in detail below with reference to FIG. 2.

The storage module 125 includes one or more machine-readable media that store data. The storage module 125 may receive and store data from a user device 105, the context map board system 120, third-party databases, and the like. The data stored may include elements, and each element may be associated with one or more data files that may be displayed as links in the interfaces of the context map board system 120. Although the storage module 125 is shown as a distinct entity connected to the context map board system 120 via the network 110, in some embodiments, the storage module 125 is part of the context map board system 120.

The user device 105, context map board system 120, and storage module 125 are configured to communicate via a network 110, which may include any combination of local area and/or wide area networks, using both wired and/or wireless communication systems. In one embodiment, a network 110 uses standard communications technologies and/or protocols. For example, a network 110 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 110 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 110 may be represented using any suitable format, such as hypertext markup language (HTML) or extensible markup language (XML). In some embodiments, all or some of the communication links of a network 110 may be encrypted using any suitable technique or techniques.

FIG. 2 shows one embodiment of the context map board system 120 of FIG. 1. In the embodiment shown, the context map board system 120 includes a data store 205, a canvas engine 210, a canvas interface 215, an outline engine 220, an outline interface 225, a table engine 230, a table interface 235, and a layer engine 240. In other embodiments, the system environment 100 includes different and/or additional elements. In addition, the functions may be distributed among the elements in a different manner than described.

The elements of the context map board system 120 work together to generate and cause display of different interfaces to allow users to simultaneously view and interact with data in multiple ways. The different interfaces also allow users to easily compare and analyze data across different entities, such as departments, companies, industries, and the like. Responsive to modification of an element via one interface, the context map board system 120 automatically propagates the modification to other ones of the interfaces.

The context map board system 120 stores data in the data store 205. In one embodiment, data are stored as elements that are each mapped to one or more interfaces such that changes to an element are propagated to each interface that includes the element. Elements may include plain text, formatted text, audio, video, tables, strings, vectors, images, and the like. In some embodiments, elements may include pointers, references, or other forms of link to files, such as rich text format files, audio files, image files, and video files. This may reduce the size of the database while providing the ability for interfaces to include audiovisual content.

The elements stored in the data store 205 are generally related to other elements. A first elements relationship with a second element may be indicated by storing an identifier of the second element in the data store 205 in conjunction with the first element. The identifier may be an element ID, a pointer to the location of second element in the data store 205, or any other appropriate identifier. A relationship may be one-way, meaning an indication of one element in a pair is stored in conjunction with the other element of the pair, but not vice versa, or two-way, meaning an indication of the other element of the pair is stored in conjunction with both elements.

In one embodiment, at least a subset of the elements stored in the data store 205 are organized using primary order numbers (PON). In such an embodiment, each of the subset of elements of the data store 205 is associated with a PON that indicates the element's position in a hierarchy relative to the other elements stored in the data store 205. Thus, elements may have parent, child, and/or sibling elements, etc. For example, a root element in the hierarchy may have a PON of 1, and the root element may have three children elements with PONs of 1.1, 1.2, and 1.3 A child of element 1.1 may have a PON of 1.1.1 while a child of element 1.2 might have a PON of 1.2.1, etc. Thus, the relationships between elements in the hierarchy can be determined from the corresponding PONs. Users may modify the relative position of the elements by modifying the PONs of the elements, modifying the position of the elements in an interface of the context map board system 120, etc. Additionally or alternatively, elements stored in the data store 205 may be organized linearly such that elements are related to each other but are not subject to a hierarchy. For example, each element may be assigned a unique identifier and a relationship between a pair of elements may be indicated by storing the unique identifier of the other element in association with one or both of the elements in the pair. Furthermore, some or all of the elements stored in the data store 205 may be independent of other stored elements.

The type of relationship, if any, between stored elements may be user-defined, and the interfaces may include elements having one or more different types of relationships. In one example, a user might create a context map board showing employees of an organization. The context map board might include a first set of elements having a hierarchical relationship and organized by PON (for example, a first set of employees for whom the employees' position in the organization is known and is subject to a hierarchy), a second set of elements having a linear relationship (for example, a second set of employees who are known to work together but for whom the organizational hierarchy is currently unknown), and a third set of elements that are independent of each other (for example, a third set of employees whose connections within the organization are currently unknown). In this way, a single context map board can include sets of elements having different types of relationships.

In one embodiment, the relationship type is updated in the data store 205 in response to user input. For example, if the positions of the third set of employees or the hierarchical relationship between employees in the second set becomes known, the user can provide input to update the data store 205 to reflect the new information. In another example, the user can provide input to move elements or change the relationship type between elements, such as by dragging one or more child elements from a first parent element to a second parent element or by changing the relationship type from hierarchical to linear. Changes to a first interface may automatically be propagated to the other interfaces, as discussed below. Still further, user interaction with an element in a first interface (e.g., clicking on an element in a table interface) automatically causes the engines of the second and third interfaces to display representations of the element (e.g., by scrolling to, zooming in on, highlighting, or otherwise distinguishing the selected element in the second and third interfaces).

The canvas engine 210, outline engine 220, and table engine 230 generate for display the canvas interface 215, outline interface 225, and table interface 235, respectively. Each interface generated by the context map board system 120 allows users to visualize and interact with data associated with elements of the data store 205 in different ways based on user preferences, varying data formats associated with elements, and the like.

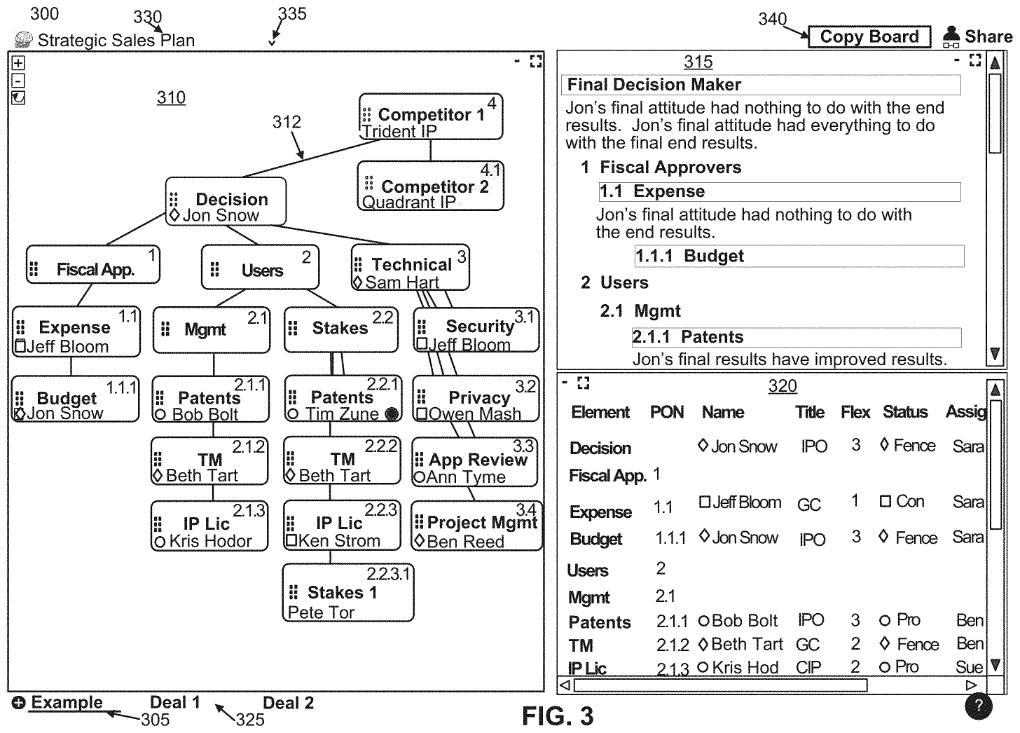

The canvas engine 210 generates for display a canvas interface 215 that displays the relationship between elements. In some embodiments, the canvas interface 215 displays elements as nodes. The nodes are geometric shapes (e.g., rectangles, circles, diamonds, etc.) arranged in the canvas interface 215 as a tree and/or context map. For example, the canvas interface 215 may display the relationship between nodes representing the departments of an organization as parent, child, and sibling nodes (as shown in the canvas interface 310 of FIG. 3). Alternatively, as discussed above, the nodes made be displayed linearly or independent of other elements.

Nodes representing elements may be organized and labeled based on one or more qualities of the elements. Examples of qualities include, but are not limited to, element names, PONs, company name, team lead, service, and the like. Qualities may be system-defined (e.g., automatically created for a project, such as the PON for each element) or user-defined (e.g., a user may add a quality relevant to the current project, such as address, business sector, etc.). Users may toggle the labels of the nodes in the canvas interface 215 using one or more interface elements. The canvas interface 215 may include additional user interface elements that allow users to add elements, remove elements, edit elements or qualities of the elements, move elements, and the like. Modifications may be automatically displayed in the outline interface 225 and table interface 235.

The outline engine 220 generates for display an outline interface 225 (as shown in the outline interface 315 of FIG. 3). The outline interface 225 displays at least some of the elements of the data store 205 in an outline format. The outline interface 225 may include an interface element associated with each element that allows users to add text associated with each element. In one embodiment, text added to an element is stored in a field of the corresponding row in the data store 205. The text may be unformatted or formatted (e.g., using rich text format). This allows users to add text without the limitations of a spreadsheet comment or column for notes. In some embodiments, when a user selects an element within the outline interface 225 (or one of the other interfaces), the outline interface 225 is updated to display a threshold portion of the text associated with the element. In embodiments in which a threshold portion of text is displayed, the user may view the remaining text by selecting an interface element, such as ellipses, “See More” text, or the like. In other embodiments, the outline interface 225 is updated to display all text associated with the element in response to user selection of the element.

The outline interface 225 may also allow users to add, remove, and/or reorganize elements of the data store 205. In embodiments that use a PON to indicate the relationships between elements, when an element is added, removed, or modified within the outline interface 225, the PON of impacted elements are automatically updated. For example, if a new element is added between first and second levels in a hierarchy, the newly added element becomes the new second level and the previous second level elements become third level elements, and their PONs are updated accordingly. The PON of the additional elements may be automatically updated or a user may be prompted to confirm the changes. In another embodiment, the data store 205 stores immediate relationships between the elements such that each element is identified based on its immediate parent in the hierarchy. For example, while a PON might indicate that a hierarchical string for an element is A.I.a.1, in another embodiment, the element “1” is identified as a first child of “a,” “a” is identified as a first child of “I,” and so on.

The table engine 230 generates for display a table interface 235 (as shown in the table interface 320 of FIG. 3). The table interface 235 displays at least some of the elements in a table and/or spreadsheet format. The table interface 235 displays multiple rows, each row associated with an element, and multiple columns, each column associated with a quality of the element. Examples of qualities include, but are not limited to, element names, PONs, company name, team lead, service, and the like. As described previously, qualities may be user-defined or system-defined. In some embodiments, one or more default qualities are displayed in the table interface 235, such as an element name and PON. Users may use one or more interface elements to adjust the default displayed qualities for the table interface 235, such as by adding or removing qualities for display. If the data of an element displayed in the table interface 235 includes a value of a quality displayed in the table interface 235, the table engine 230 may automatically generate for display the value of the quality. If the data of an element displayed in the table interface 235 does not include the value, the user may be prompted to add a value of the quality. Alternatively, the value may be left blank. Similarly, if a user edits a value of an element, the data associated with the element in the data store 205 may be automatically updated to reflect the edit. Additional functionality provided in the table interface 235 allows a user to filter or sort elements and hide rows and columns in the table interface 235. In one embodiment, hiding elements or qualities in the table interface 235 causes the canvas engine 210 and the outline engine 220 to hide the corresponding elements or qualities in the canvas interface 215 and outline interface 225.

In some embodiments, users may perform operations on the values displayed within the table interface 235. The products of the operation may be automatically stored in the data store 205. Operations within a layer of the table interface 235 may be performed row-wise and/or column-wise. Row-wise operations may include generating a statistic, score, etc., based on the value of one or more qualities of an element. For example, the table engine 230 may calculate an efficiency score based on the qualities of an element, a net profit of an element may be determined, and the like. Column-wise operations may include generating a statistic, score, etc., based on the values of a quality across multiple elements. For example, an average value of a quality across elements may be determined, a total number of employees may be calculated, a total budget may be calculated, and the like.

In some embodiments, if a value is added to a parent element, the value may be automatically added to the child elements. For example, if a company location is added to a parent element, the company location may be automatically added to the children elements. The user may edit the company location of one or more child elements if the value is not correct using user interface elements of the table interface 235. Alternatively, if the value of the quality conflicts with data of the element stored in the data store 205, the user may be prompted to address the conflict.

The layer engine 240 generates layers for the context map board representing a collection of values for qualities of the elements. Each layer may include a framework of identical elements, element relationships, and element qualities, but different element quality values such that information across departments, companies, industries, etc., may be easily compared. For example, a context map board may include a first layer representing a first location of a hotel chain, a second layer representing a second location, and so on. In some embodiments, the context map board includes a functional layer generated based on values of one or more qualities in other layers, such as an average satisfaction rate of each hotel location's restaurant.

Users may add layers to the context map board using an interface element of either the canvas interface 215, outline interface 225, and/or table interface 235. In one embodiment, when a user requests to generate an additional layer, the layer engine 240 uses a first layer as a template to generate the additional layer. The additional layer may include some or all of the structural elements of the first layer, including element names PONs, quality names, and the like. Text associated with the elements in the outline interface 225 and values associated with the qualities in the table interface 235 may be blank such that the user may add the values corresponding to the entity associated with the additional layer. Alternatively, the context map board system 120 may automatically add values of element qualities to the additional layer based on the data set. Blank values may be highlighted to indicate missing data, discrepancies in data values, and the like.

Layers may be coupled so that when a quality is added to one layer, it is automatically added to the other layers. In some embodiments, when a quality is removed, the quality is automatically removed from all coupled layers. In other embodiments, a user may be prompted by a user interface element to confirm if the quality should be removed from all other layers. In some embodiments, when a quality is deleted from an interface, the corresponding values are deleted from the data store 205. In other embodiments, the quality may be saved in the data store 205 so that the data is preserved even when a layer is modified. For example, a user may want to compare qualities A, B, C, and D of two companies, but a table interface 235 of a first company displays qualities A, B, C, D, and E. The user may request to remove quality E from display, but the value of quality E of the first company may be retained in the data store 205. Still further, as discussed above, a quality that is moved in one layer may automatically be moved in all other coupled layers. For example, if a user modifies a PON of an element by moving the element in the canvas interface 215, the PON and position of the element are adjusted in the other interfaces of the same layer as well as in all other coupled layers.

The layer engine 240 allows user to toggle between layers in each interface via selection of an interface control. In some embodiments, toggling to one layer in one interface may automatically toggle the other interfaces to display the same layer. In alternative embodiments, a user may be able to view one layer in one interface and an alternative layer in an alternative interface. For example, the outline interface 225 may display an outline of a first company and the table interface 235 may display a table of second company.

Further, users may be able to pivot the views of the interfaces to view multiple layers within one interface. User interfaces displayed within a pivoted view may include interface elements that allow users to add data and/or perform functions across layers. For example, a table engine 230 may perform operations on data displayed within the table interface 235 across layers.

Some functions can be performed on data displayed in all interfaces of the context map board system 120. For example, users may modify the relative position of the elements in all interfaces of the context map board system 120. Other functions may be performed in particular subsets of the interfaces. For example, math operations may be interface-specific. Still other functions can be performed across layers. For example, a functional layer may be created based on values of one or more qualities in other layers, such as a mean, median, or mode of the quality values, a highest or lowest of the quality values, or a product or sum of the quality values. Similarly, in some embodiments, functions may be performed at the cell, column, or row level in the table interface 235 to generate a functional cell, functional column, or functional row. For example, a column may be a function of one or more other columns in the table interface 235 (i.e., may be generated based on values of one or more qualities in other columns), such as a mean of quality values of the other columns. Similarly, a functional row may be generated based on values of one or more qualities in other rows. Modifications made to elements in an interface of the context map board system 120 may be stored as data of the element in the data store 205.

Additionally, one or more of the interfaces may be color-coded. In one embodiment, the canvas engine 210, outline engine 220, and table engine 230 automatically color code the respective interfaces based on a PON. For example, for a context map board describing the organizing of a law firm's patent group, a first color may be assigned to one or more employees represented by a parent element (e.g., a partner), a second color may be assigned to employees represented by a child element (e.g., an associate), a third color may be assigned to employees represented by a grandchild element (e.g., a paralegal), and the like. In another example, color-coding may be based on non-hierarchical groupings of elements. For instance, elements representing the law firm's patent group may be assigned a first color, elements representing the firm's trademark group may be assigned a second color, and so on. In embodiments in which elements have a linear relationship, each set of elements or each element in a set may be assigned a different color. Still further, each independent element may be assigned a different color. While color-coding may be assigned automatically by the canvas engine 210, outline engine 220, and table engine 230, in some embodiments, a user may provide input to assign a color to one or more elements or change a color assigned by the canvas engine 210, outline engine 220, or table engine 230.

FIG. 3 illustrates an example user interface showing a context map board 300, in accordance with an embodiment. In the embodiment shown in FIG. 3, the context map board 300 includes a first layer 305 with a canvas interface 310, an outline interface 315, and a table interface 320. As discussed above, the context map board 300 can include multiple layers, including one or more functional layers representing operations performed on other coupled layers. The user interface of FIG. 3 includes interface elements 325 allowing the user to toggle between layers of the context map board 300. For example, user selection of the “Deal 1” interface element causes the context map board system 120 to display a layer associated with Deal 1. Selection of the “Deal 2” element similarly causes the context map board system 120 to display the Deal 2 layer. Still further, the user interface elements also allow a user to add a new layer to the context map board and to rename or reorder existing layers (e.g., by selecting and dragging a layer that the user wishes to move).

The context map board 300 includes a title field 330 in which user can input a title or modify an existing title of the context map board 300. In one embodiment, the context map board 300 includes a drop-down menu 335 to allow the user to switch between existing context map boards 300 or to create a new context map board 300. Still further, the context map board 300 includes interface elements 340 with which the user can interact to copy or share the context map board 300, such as with other users of the context map board system 120.

As discussed above, the canvas interface 310 is generated by the canvas engine 210 and displays relationships between elements associated with the context map board 300. The elements displayed in the canvas interface 310 are organized as nodes having a hierarchical relationship. However, in other embodiments, the elements displayed in the canvas interface 310 have linear relationships or are independent of other displayed elements. The canvas interface 310 can include elements having different relationships. For example, a first set of displayed elements might have a hierarchical relationship while a second set of elements may be independent of each other.

Each node in the canvas interface 310 may be labeled based on one or more qualities of the element. In the embodiment displayed in FIG. 3, element labels include element names, PON, a username associated with the element and one or more icons indicating a status of the user, as discussed below with respect to the table interface 320. Additionally, each node may include a handle to indicate to the user that the node may be dragged or otherwise moved to another location in the canvas interface 310. Edges connect pairs of elements to indicate or represent relationships between elements. For example, edge 312 indicates a relationship between “final decision maker” and “competitor 1.” The canvas engine 210 may color-code the elements based on element relationship, element type, or based on user input defining or modifying assigned colors. Additional interface elements of the canvas interface 310 provide functionality allowing the user to zoom in or out on specific portions of the canvas interface 310.

The outline interface 315 is generated by the outline engine 220, as described above with respect to FIG. 2. Elements in the outline interface 315 are displayed in outline format with elements organized, for example, based on PON. In one embodiment, each element displayed in the outline interface 315 includes a text field in which the user can add text associated with the element or modify existing text. Displayed text may further include hyperlinks to data files associated with the element. Still further, each element name in the outline interface 315 may be color-coded in accordance with the color-coding in the canvas interface 310 and table interface 320. If a user modifies an assigned color of an element in a first interface, the engines associated with the second and third interfaces automatically update the color-coding of the corresponding elements in those interfaces. Still further, the outline interface 315 includes a scroll bar that allows the user to scroll vertically through the outline to view additional elements and text not captured in the threshold portion of the canvas interface 315 displayed in the context map board 300.

The table interface 320 is generated by the table engine 230, as discussed above with respect to FIG. 2. The table interface 320 displays the elements in table or spreadsheet format with elements organized into columns and rows. In one embodiment, each element is represented as a row in the table interface 320, and each column indicates a quality of the corresponding element. The example qualities displayed in FIG. 3 include element name, PON, username, user title, user level, and user status, though additional or different qualities may be included in other embodiments. A specified value of a quality for an element is represented as a cell in the table interface 320. Cells in the table interface 320 may display the value of the quality for the element or may be blank, for example, if the user has not provided the quality value for the element or if the element type suggests that no quality value applies (e.g., if the element represents a heading and not a specific person or entity). The table engine 230 may automatically add data to the blank cells based on data stored in the data store 205 or may highlight the blank cells to indicate missing data, discrepancies in quality values, and the like. Still further, the table interface 320 includes vertical and horizontal scroll bars that allows the user to scroll through the outline to view additional elements and qualities not captured in the threshold portion of the table interface 320 displayed in the context map board 300.

In one embodiment, the user may assign a status icon to one or more qualities of the elements displayed in the table interface 320. The meaning of a status icon may be user-defined or may be based on a default icon meanings generated by the context map board system 120. For example, status icons in the table interface 320 indicate that the users associated with the displayed elements each have a status of either “Pro” (designated in the table interface 320 as a circle), “Con” (designated as a square), or “Fence” (designated as a diamond). The status icons may vary in shape, color, fill type, size, and/or any other visual parameter. Additional or different statuses may be used in other embodiments.

Each of the canvas interface 310, the outline interface 315, and the table interface 320 includes interface elements allowing the user to adjust the size of the respective interface relative to the other interfaces, such as by minimizing the respective interface or by expanding the respective interface to a full-screen view such that only one or two of the interfaces are displayed. Additionally, in one embodiment, user selection of an element in one interface causes the engines associated with the other interfaces to highlight or otherwise distinguish the corresponding element in those interfaces.

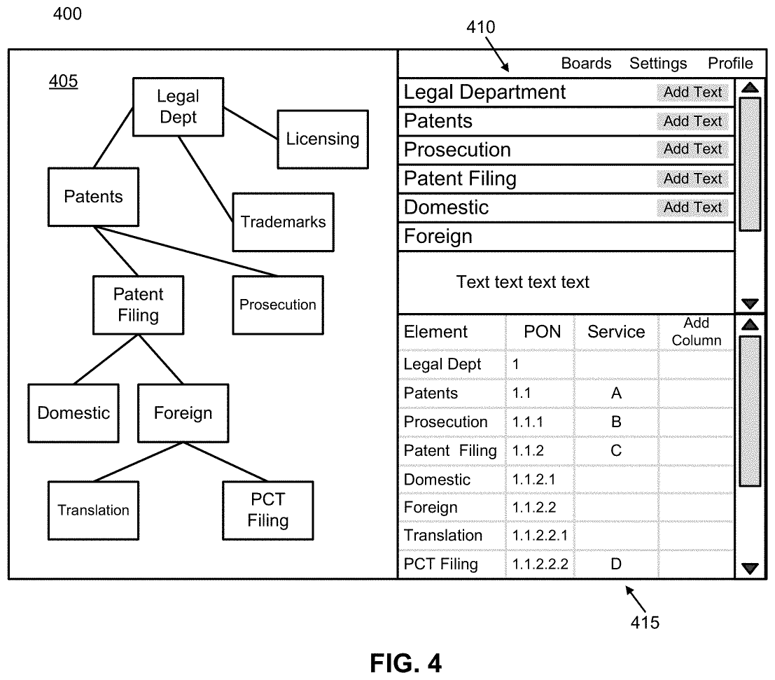

FIG. 4 is additional example user interface associated with a use case for a context map board of an intellectual property (IP) legal department, in accordance with an embodiment. In the use case associated with FIG. 4, Marta, a Customer Success Manager for an IP software company needs to understand how clients are both using and not using her company's product. While existing tools help her understand how clients are using the product, based on application report data, support requests, and the like, the only data available for features or services that are not being used is that the users are not using them. Marta does not know what alternatives her customers are using or why or how those products are connected to her customers' internal business processes.

To answer these questions, Marta wants to gather all of the applications and services that her clients are using to do other work related to the work for which they use her products and services. She starts to gather information in a conventional spreadsheet, but it starts to get confusing because they are business functions that have sub processes that need to be broken down to multiple levels to reveal the many different products and services that her clients use. The spreadsheet gets messy because there are so many rows and it is not easy to show the relationships between the parent and child processes. Nor does the spreadsheet tell the whole story. Marta needs to capture subprocesses and sub-subprocesses to accurately portray the granularity of the data. While she tries to present this information in a table format, the table gets increasingly harder to digest when subprocesses are added.

If Marta wants to capture even more information, such as how much her clients are spending on the solutions, a rating of how satisfied they are with the solutions, etc., the table gets even wider and the information harder to digest. While spreadsheets have color-coding to help make sense of the data, context can be lost when the data is forced into a spreadsheet-only use case. Marta may choose to link the spreadsheet to a concept map. Conventional products for creating concept maps may be linked to spreadsheets through a tedious manual process of linking each item in the concept map to a row in a table. However, this process is difficult and increasingly time-consuming with large numbers of items and rows.

If Marta wants to then capture the same information for a different client, she could make a copy of the spreadsheet and delete the values in the columns to use the spreadsheet as a template. But if she makes any changes to the template, those changes will not easily proliferate through the other sheets. Making those changes in the other sheets would require a significant amount of manual work with a high risk of error or a highly technical implementation using a scripting language (e.g., Visual Basic). Neither is a realistic option for this particular user. Another alternative would be for Marta to add many more columns to her existing table to reproduce the existing columns for each company. It may be possible to create a pivot table in Excel, but doing so would require high-level spreadsheet skills that may be beyond Marta's capability. Further, Marta could add fields to her CRM database to capture this data, but doing so would be a very complicated implementation beyond even an advanced user of such a system. Finally, Marta may wish to include notes describing her findings, but it may be challenging deciding where to put them. If she puts the notes in a comment, the information is not easily seen by anyone looking at the data. If she puts the notes in a document, the context is lost. She could add a link to the document in a “Notes” field of the spreadsheet, but the link is subject to breaking if the document is moved or if permissions prevent access to another reader of the file.

The above and other problems are addressed through use of the example context map board 400 shown in FIG. 4. Marta can create a mind map of processes or capabilities that are standard in a customer environment. Each of the processes can be easily broken down into subprocesses, as needed, to an infinite number of levels. Each process and subprocess is an element that makes up a map in the canvas interface 405 of the context map board 400. As each process element is created in the canvas interface 405, the outline engine 220 and the table engine 230 automatically add a new row to each of the outline interface 410 and the table interface 415. Marta may then edit the table interface 415 by adding columns and entering data into each row for that column (for example, Services A-D in the Service column of the table interface 415). Marta may also add subprocesses as child and grandchild elements of the canvas interface 405 and may include notes and other contextual data for each element as text in the outline interface 410. Still further, if Marta wished to capture the same information for a different client, she could add a layer to the context map board 400. As discussed above with respect to FIG. 2, in one embodiment, each layer of the context map board 400 shares the some or all of the same elements, such as element names, PONs, quality names, and the like. Text associated with the elements may be blank such that Marta may add values corresponding to the different client associated with the additional layer. Further, if Marta added a new element or moved an existing element, the change would propagate across all layers. Additionally, Marta may provide input to pivot the table interface 415 to show all layers for a single element (layers pivot) or all elements for a single layer (elements pivot).

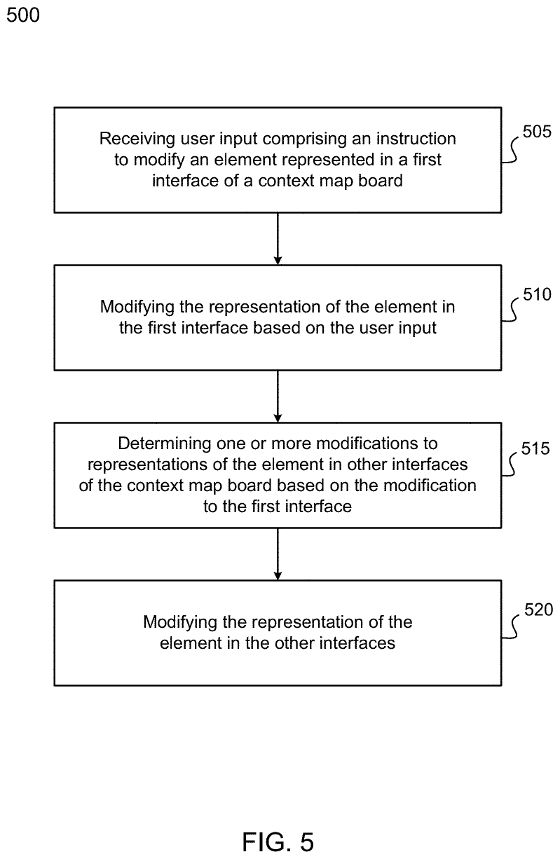

FIG. 5 is a flowchart illustrating a method 500 for automatically updating coupled interfaces of a context map board based on user input, according to an embodiment. The steps of FIG. 5 are illustrated from the perspective of the context map board system 120 performing the method 500. However, some or all of the steps may be performed by other entities and/or components. In addition, some embodiments may perform steps in parallel, perform the steps in different orders, or perform different steps.

The context map board of FIG. 5 includes a plurality of interfaces each displaying a representation of a subset of elements in a dataset. The method 500 begins with receiving 505, user input comprising an interaction with an element represented in a first interface of a context map board. As discussed above with respect to FIGS. 1-4, each context map board includes a canvas interface 215, an outline interface 225, and a table interface 235. Each of the interfaces 215, 225, and 235 may contain representations of some or all of the elements. The different interfaces may present element data (e.g., values of element qualities) in different formats, such as a canvas format, an outline format, and a table format. Additionally, each element displayed in the context map board is associated with a mapping that couples the element to each of the interfaces 215, 225, and 235.

Responsive to receiving the user input, the engine corresponding to the first interface (i.e., the interface with which the user interacted) modifies 510 the element in accordance with the user input as well as the representation of the element in the first interface. For example, in one embodiment, the user input comprises an instruction to modify the position of a first element in the canvas interface 215. In this example, the user can provide input by dragging the element to a different part of the canvas interface (e.g., to make the element a child of a different parent element or to change the relationship type between elements from hierarchical to linear) or by changing the PON of the element. The canvas engine 210 then modifies the representation of the element (here, the element's position) in the canvas interface 215 and stores the modification (e.g., the updated position and, optionally, an updated PON for the element) as data of the element in the data store 205.

At 515, the engines associated with the second and third interfaces (i.e., the interfaces that the user did not modify) determine one or more modifications to the representations of the first element in the second and third interfaces based on the modification to the element initiated from the first interface. As discussed above, the mappings couple the element to each of the interfaces 215, 225, and 235 such that modifications made to an element using one interface are propagated to each interface including that element. In the example noted above in which the user provided input to modify the canvas interface 215, the outline engine 220 and the table engine 230 determine one or more corresponding modifications to the outline interface 225 and the table interface 235. For instance, if the canvas engine 210 modifies the position of the first element, and if the first element is included in the outline interface 225 and the table interface 235, the outline engine 220 and table engine 230 determine updated positions for the first element and modify 520 the representation of the element in the associated interfaces (e.g., by adjusting the position of the row corresponding to the first element in the table interface 235 and the first element's position in the outline interface 225).

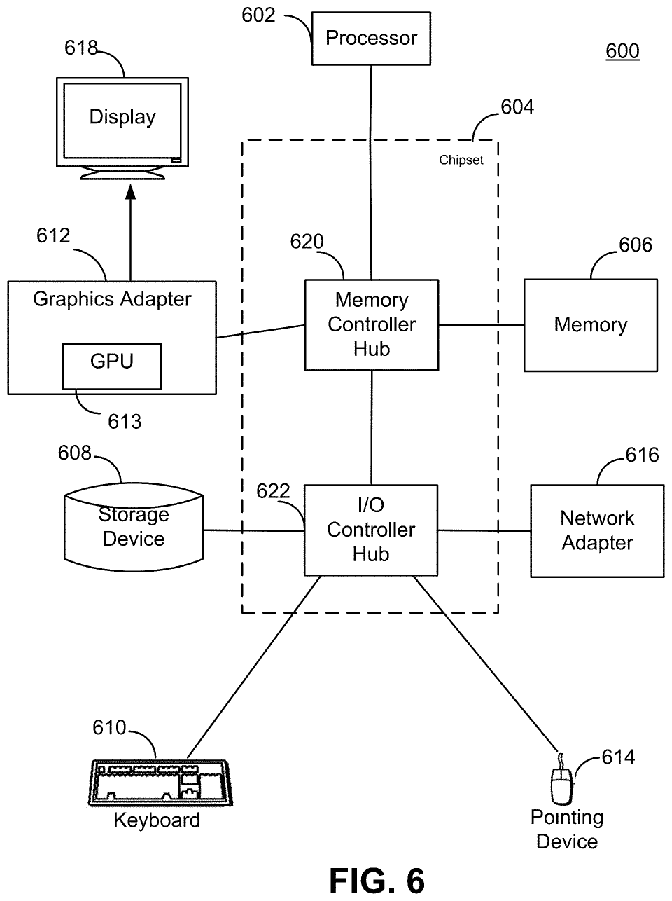

FIG. 6 is a high-level block diagram illustrating an example computer 600 suitable for implementing the entity of FIGS. 1 and 2. The example computer 600 includes at least one processor 602 coupled to a chipset 604. The chipset 604 includes a memory controller hub 620 and an input/output (I/O) controller hub 622. A memory 606 and a graphics adapter 612, which contains a graphics processing unit (GPU) 613, are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touch-screen, or other type of pointing device, and is used in combination with the keyboard 610 (which may be an on-screen keyboard) to input data into the computer 600. The graphics adapter 612 displays images and other information on the display 618. The network adapter 616 couples the computer 600 to one or more computer networks.

The GPU 613 in the graphics adapter 612 may be used for other high-performance computation as well as processing graphical data for presentation on the display 618. In one embodiment, the GPU 613 is used to process data from the context map board system 120.

The types of computers used by the entities of FIG. 6 can vary depending upon the embodiment and the processing power required by the entity. For example, the context map board system 120 might include a desktop computer to provide the functionality described. Furthermore, the computers can lack some of the components described above, such as keyboards 610, graphics adapters 612, and displays 618.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for automatically updating coupled interfaces of a context map board based on user input. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein. The scope of the invention is to be limited only by the following claims.

What is claimed is:

1. A non-transitory computer-readable medium comprising instructions that, when executed by a computing device, cause the computing device to perform operations including:
retrieving elements of a data set from a data store, each element including values of a set of qualities of the element;
displaying a context map board having a plurality of interfaces, the plurality of interfaces comprising:
a canvas interface including nodes and edges, the nodes representing the elements and the edges representing relationships between the elements;
an outline interface representing at least some of the elements in an outline format, the outline interface including an interface element enabling a user to associate text with an element; and
a table interface representing at least some of the elements in a table format, each row of the table interface associated with an element and each column of the table interface associated with a quality of the elements; and
responsive to modification of an element via one interface, automatically propagating the modification to other ones of the interfaces.

2. The non-transitory computer-readable medium of claim 1, wherein at least a subset of the elements have a hierarchical relationship and wherein each element in the hierarchical relationship is associated with a primary order number representing a position of the element relative to one or more other elements in the hierarchical relationship.

3. The non-transitory computer-readable medium of claim 1, wherein a first element and a second element have a linear relationship and wherein an indication of the second element is stored in association with the first element.

4. The non-transitory computer-readable medium of claim 1, wherein the context map board further comprises an interface control configured to enable a user to toggle between multiple layers, each layer including a set of identical framework of elements, element relationships, and element qualities but wherein values of the element qualities differ between the layers.

5. The non-transitory computer-readable medium of claim 4, wherein the multiple layers include a functional layer generated based on values of one or more qualities in other layers.

6. The non-transitory computer-readable medium of claim 4, wherein values of element qualities are automatically added to at least some of the layers based on the data set.

7. The non-transitory computer-readable medium of claim 4, wherein toggling from a first layer to a second layer in one interface also toggles from the first layer to the second layer in other ones of the interfaces.

8. The non-transitory computer-readable medium of claim 1, wherein at least one of the columns in the table interface is a functional column generated based on values of one or more qualities in other columns.

9. The non-transitory computer-readable medium of claim 1, wherein at least one of the rows in the table interface is a functional row generated based on values of one or more qualities in other rows.

10. A context map board comprising:
a canvas interface displaying nodes and edges, the nodes representing elements of a data set and the edges representing relationships between the elements;
an outline interface representing at least some of the elements in an outline format, the outline interface including an interface element enabling a user to associate text with an element; and
a table interface representing at least some of the elements in a table format, each row of the table interface associated with an element and each column of the table interface associated with a quality of the elements,
wherein the canvas interface, the outline interface, and the table interface are coupled such that a modification to an element via one interface is automatically propagated to other ones of the interfaces.

11. The context map board of claim 10, wherein at least a subset of the elements have a hierarchical relationship and wherein each element in the hierarchical relationship is associated with a primary order number representing a position of the element relative to one or more other elements in the hierarchical relationship.

12. The context map board of claim 10, wherein a first element and a second element have a linear relationship and wherein an indication of the second element is stored in association with the first element.

13. The context map board of claim 10, wherein the context map board comprises multiple layers, each layer having a framework of identical elements, element relationships, and element qualities but wherein values of the element qualities differ between the layers.

14. The context map board of claim 13, further comprising a functional layer generated based on values of one or more qualities in other layers.

15. The context map board of claim 13, wherein values of element qualities are automatically added to one or more additional layers based on the data set.

16. The context map board of claim 13, wherein toggling from a first layer to a second layer in one interface also toggles from the first layer to the second layer in other ones of the interfaces.

17. The context map board of claim 10, wherein at least one of the columns in the table interface is a functional column generated based on values of one or more qualities in other columns.

18. The context map board 10, wherein at least one of the rows in the table interface is a functional row generated based on values of one or more qualities in other rows.

19. The context map board of claim 10, wherein user input comprising an interaction with a representation of an element in one interface automatically causes other ones of the interfaces to display representations of the element.

20. A method for updating a context map board having a plurality of interfaces, each of the plurality of interfaces displaying a representation of a subset of elements in a dataset, the method comprising:
receiving user input including an instruction to modify an element represented in a first interface of the plurality of interfaces;
modifying a representation of the element in the first interface based on the user input;
determining one or more modifications to representations of the element in other interfaces of the context map board based on the modification to the first interface; and
modifying the representations of the element in the other interfaces.
